(19) United States
(12) Patent Application Publication
(10) Pub. No.: US 2003/0144846 A1
(43) Pub. Date: Jul. 31, 2003

(54) Method and system for modifying the behavior of an application based upon the application's grammar

(76) Inventors: Lawrence A. Denenberg, Brookline, MA (US); Christopher M. Schmandt, Winchester, MA (US)

Correspondence Address: MINTZ, LEVIN, COHN, FERRIS,, GLOVSKY AND POPEO, P.C., One Financial Center, Boston, MA, 02111, US

(21) Appl. No.: 10/066,154

(22) Filed: Jan. 31, 2002

(51) Int. Cl. G10L 21/00

(52) U.S. Cl. 704/277

(57) ABSTRACT

A voice application platform receives information, such as a grammar and/or a prompt, from an application, which is indicative of the response(s) that the application expects. The voice application platform modifies the way the user can interact with the user interface and the application as a function of the expected responses. The voice application platform can provide a more consistent user interface by enabling the user to use terms or commands that the user is familiar with to interact with the application and the voice application platform performs the conversion between the user response and the response expected by the application in a manner transparent to the user and the application. The voice application platform can store information about the user and provide the appropriate information to the application (as requested) automatically based upon prior authorization from the user or by the voice application platform prompting the user on an as necessary basis. The voice application platform can also provide contextually based added functionality that is apparent or transparent to the user, for example, help for the user interface commands and help for the remote application.

### CROSS-REFERENCE TO RELATED APPLICATIONS

Not Applicable

### STATEMENT REGARDING FEDERALLY SPONSORED RESEARCH

Not Applicable

### REFERENCE TO MICROFICHE APPENDIX

Not Applicable

### BACKGROUND OF THE INVENTION

This invention relates to methods and system for providing voice based user interfaces for computer based applications and, more particularly, to a method and system which modifies the way a user can interact with an application as a function of an analysis of the expected user responses or inputs (e.g. grammars) to the application.

The Internet and the World Wide Web (“WWW”) provide users with access to a broad range of information and services. Typically, the WWW is accessed by using a graphical user interface (“GUI”) provided by a client application know as a web browser such as Netscape Communicator or Microsoft Internet Explorer. A user accesses the various resources on the WWW by selecting a link or entering alpha-numeric text into web page that is sent to a server that selects the web page to be viewed by the user. While a web browser is well suited to provide access from a computing device, such as a desktop or laptop computer, that has a relatively large display, the GUI is not well suited for smaller and more portable devices which have small display components (or no display components) such as portable digital assistants (“PDAs”) and telephones.

In order to access the Internet via one of these small and portable devices, for example, a telephone, an audio or voice-based application platform must be provided. The voice application platform receives content from a website or an application and presents the content to the user in the form of an audio prompt, either by playing back an audio file or by speech synthesis, such as that generated by text-to-speech synthesis. The website or application can also provide information, such as a speech recognition grammar, that enables or assists the voice application platform to process user inputs. The voice application platform also gathers user responses and choices using speech recognition or touch tone (DTMF) decoding. Typically, the provider of access to the Internet via telephone provides their own user interface, a voice browser, which provides the user with additional functionality apart from the user interface provided by a website or an application. This functionality can include navigational functions to connect to different websites and applications, help and user support functions, and error handling functions. The voice browser provides a voice or audio interface to the Internet the same way a web browser provides a graphical interface to the Internet. Similarly, a developer can use languages such as VoiceXML to create voice applications the same way HTML and XML are used to create web applications. VoiceXML is a language like HTML or XML but for specifying voice dialogs. The voice applications are made up of a series of voice dialogs which are analogous to web pages. The VoiceXML data is typically stored on a server or host system and transferred via a network connection, such as the Internet, to the system that provides the voice application platform and optionally, a voice-based browser user interface, however, the VoiceXML data, the voice application platform and the voice user interface can reside on the same physical computer.

Voice dialogs typically use digital audio data or text-to-speech (“TTS”) processors to produce the prompts (audio content, the equivalent of the content of a web page) and DTMF (touch tone signal decoding) and automatic speech recognition (“ASR”) to receive input selections from the user. The voice application platform is adapted for receiving data, such as VoiceXML, from an application of a website which specifies the audio prompts to be presented to the user and the grammar which defines the range of possible acceptable responses from the user. The voice application platform sends the user response to the application or website. If the user response is not within the range of acceptable responses defined for the voice dialog, the application can present to the user an indication that the response is not acceptable and ask the user to enter another response.

The voice application platform can also provide what have been called “hotwords.” Hotwords are words added by the voice application platform to provide additional functionality to the user interface. These extensions to the user interface allow a user to quit or exit a website or an application by saying “quit” or “exit” or allow the user to obtain “help” or return to a “home” state within the voice application platform. These key words are added to every dialog without consideration of the user interface provided by the website or the application and regardless of the commands provided by user interface of the website or the application. This can lead to problems in the prior art systems because if the website or application user interface provides for the command “help” and the voice application platform adds the command “help” to the user interface, the voice application platform now has a conflict as to how to proceed if the user says “help.” Because of this conflict, there is a possibility that the voice application platform will not provide the appropriate response to the user.

In U.S. Pat. No. 6,058,366 a voice-data handling system is disclosed which uses an engine to invoke specialized speech dialog modules or tools at run-time. While this prior art system affords some extension because the specialized dialog modules can be modified independently of the underlying application, the system requires the developer to know in advance that specific dialog modules or dialog tools are available. Thus, if new dialog modules or dialog tools are developed, the developer would have to rewrite the underlying application in order to take advantage of the new functionality.

Accordingly, it is an object of the present invention to provide an improved user interface.

It is another object of the present invention to provide an improved user interface that can modify the acceptable user responses or inputs to provide an enhanced user interface.

It is a further object of the present invention to provide an improved user interface that modifies the way the user can interact with the underlying application.

### SUMMARY OF THE INVENTION

The present invention is directed to a method and system for providing an intelligent user interface to an application or a website. The invention includes analyzing data, including but not limited to prompts and grammars, from an application and modifying the voice user interface (“VUI”) in response to the analysis. (We will also referred to this data from the application as “inputs from the application”.) The modifications make the VUI easier to use and more functional. Some embodiments transparently user a speech recognizer of a type, e.g. grammar-based, n-gram or keyword, other than the type expected by the application. Some embodiments choose to speech recognizer type in response to the above-mentioned analysis. We will also referred to modifications to the VUI as changing the “allowable” or “acceptable” user inputs, or the like. This can be implemented by modifying the grammar of a grammar-based speech recognizer, but it but it can also be done in other ways, depending on the type of speech recognizer used, as explained below.

The user interacts with an application through one or more dialogs that present content or information to the user and expect a response back from the user. In this context, a web page can be considered an application to the extent it provides content or information to a user and permits the user to respond by selecting on links or other controls on the page. In the context of an application providing a voice user interface, the content and information are provided in audio form and the responses are provide in either spoken commands or touch tone (DTMF) signals. The method and system in accordance with the present invention modifies, and therefore enhances the user interface to an application by: (a) adding to, deleting from, changing and/or replacing the prompts; (b) and modifying (generally augmenting) the permitted user inputs or responses; (c) carrying on a more complex dialog with the user than the application intended, possibly returning some, none or all of the user's inputs to the application; (d) modifying and/or augmenting user inputs or responses and providing the modified input or response to the application; and/or (e) automatically generating a response to the application, without necessarily requiring the user to say anything and possibly without even prompting the user. The method and the system of the present invention include evaluating the information received from the application as well as the context within which it is received in order to make a determination as to how to modify the way the user can interact with the application. The present invention can also be used to provide a more consistent and effective user interface.

The present invention can be used to provide a more consistent user interface by examining the commands used by the application and adding to or replacing the permitted responses with command terms with which the user may be more familiar or are synonyms of the command terms provided by the application. For example, an application may use the command “Exit” to terminate the application, however the user may be used to or familiar with using the term “Quit” or “Stop”, so the term “Quit” (and/or “Stop”) can be substituted, or more preferably, added to the list of permitted responses expected by the application and the voice application platform can, upon input by the user of one of the added or alternate responses, substitute the permitted response specified by the application. Further, a system in accordance with the invention can, upon receiving one of the substitute or alternate responses, such as “Quit,” replace that response with the application permitted response, “Exit” in a manner that is transparent to the user and the application.

The present invention can be used to provide an improved user interface by examining the permitted responses and providing additional functionality, such as error handling, detailed user help information, permitting DTMF (touch tone decoding) when not provided for by the underlying application, and/or provide for improved recognition of more natural language responses. For example, an application may be expecting a specific response, such as a date or an account number and the user permitted input specified by the application may be limited to specific words or single digit numbers. The voice application platform can improve the user interface by adding relative expressions for dates (e.g. “next Monday” or “tomorrow”) or by expanding the acceptable inputs or responses to include number groupings (e.g. “twenty-two,” “three hundred” or “twelve hundred”). Similarly, where the voice application platform detects that the application is expecting the user to input information that has been previously stored in a user profile or database (for example, credit card numbers, birth dates or addresses), the user interface can either automatically send the information, thereby eliminating a need for the user to input the information and possibly eliminating a need to even prompt the user, or give the user the option of using the previously stored information by inputting a special command, such as, for example, “use my MasterCard” or by pressing the “#” key. Alternatively, the user interface can permit the user to use alpha-numeric keys, such as the keys on the telephone, to input the alpha-numeric information.

The system and method according to the present invention can provide an improved user interface which can permit the input of natural language expressions. Thus, the voice application platform in accordance with the invention can provide an improved user interface which can accept the input of phrases and sentences instead of simple word commands and convert the phrases and/or sentences into the simple word commands expected by the application. Thus, for example, the user could input the expression “the thirtieth of January” or “January, please”. In general, words of politeness or “noise” words people tend to include in their speech can be added to the acceptable user inputs to increase the likelihood of recognizing a user's input.

The system and method according to the present invention can also provide an improved user interface which can permit the input of relative expressions. Thus, for example, where a voice application requested the user to input a date, the user could input a relative expression such as “January tenth of next year” or “a week from today.”

The present invention can also be used to provide a user interface that can be extended to support new or different voice application platform technologies that are not contemplated by the developer of the website or the application. Thus, for example, the input or grammar provided to the voice application platform by the application can be a specific type or format that conforms to a specific standard (such as the W3C Grammar Format) or compatible with a particular recognizer model or paradigm at the time the application was developed. The present invention can be used to detect the specific type of grammar or input provided by the application and convert it to or substitute it for a new or different type of data (such as a template for natural language (n-gram) parser or set of keywords for a keyword recognizer ) that is compatible with the recognition model or paradigm supported by the voice application platform. The substituted data can also provide an improved user interface as disclosed herein. In addition, the substituted data can also provide for better recognition of natural language responses or even recognition of different languages. Alternatively, where the voice application platform uses a speech recognizer that does not need an input (such as a grammar), for example, an open vocabulary recognizer, the present invention can allow such a voice application platform to ignore the grammar or to use the grammar to determine the desired response and serve as a simple integrity check on the response received from the user. In addition, the voice application platform can be used with both grammar-based applications and applications that do not use grammar, such as open vocabulary applications.

The present invention can be used to provide an improved user interface by examining the prompt information and the grammar or other information provided by the application.

### BRIEF DESCRIPTION OF THE DRAWINGS

The foregoing and other objects of this invention, the various features thereof, as well as the invention itself, may be more fully understood from the following description, when read together with the accompanying drawings in which:

FIG. 1 is a block diagram of a system for providing an improved user interface in accordance with the present invention;

FIG. 2 is a block diagram of a user interface in accordance with the present invention; and

FIG. 3 is a flow chart showing a method of providing a user interface in accordance with the present invention.

### DETAILED DESCRIPTION OF THE PREFERRED EMBODIMENTS

The present invention is directed to a method and system that provides an improved user interface that is expandable and adaptable. In order to facilitate further understanding, one or more illustrative embodiments of the invention are described. The illustrative embodiments concern a system which includes a voice application platform that receives information from an application, which defines how the user and the application interact with each other. In accordance with the invention, the voice application platform is adapted to analyze the information received from the application and modify the way the user can interact with the application. The invention also concerns a method or process for providing a user interface which includes receiving information from an application which defines how the user and the application interact with each other. In accordance with the invention, the process further includes analyzing the information received from the application and modifying the way the user can interact with the application.

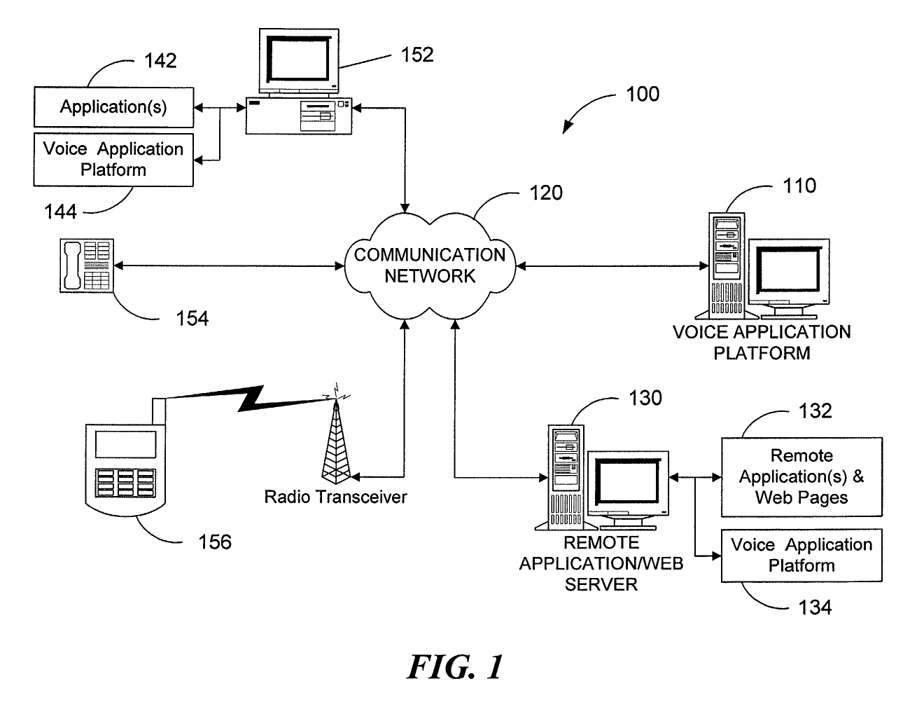

FIG. 1 shows a diagrammatic view of a voice based system 100 for accessing applications in accordance with the present invention. The system 100 can include a voice application platform 110 coupled to one or more remote application and/or web servers 130 via a communication network 120, such as the Internet, and coupled to one or more terminals, such as a computer 152, a telephone 154 and a mobile device (PDA and/or telephone) 156 via network 120. The terminals 152, 154 and 156 can be equipped with the necessary voice input and output components, for example, computer 152 can be provided with a microphone and speakers. The application/web server 130 is adapted for storing one or more remote applications and one or more web pages 132 in a storage device (not shown). The remote applications can be any applications that a user can interact with, either directly or over a network, including, but not limited to, traditional voice applications, such as voice mail and voice dialing applications, voice based account management systems (for example, voice based banking and securities trading), voice based information delivery services (for example, driving directions and traffic reports) and voice based entertainment systems (for example, horoscope and sports scores), GUI based applications such as email client applications (Microsoft Outlook), and web based applications such as electronic commerce applications (electronic storefronts), electronic account management systems (electronic banking and securities trading services) and information delivery applications (electronic magazines and newspapers).

The voice application platform 110 can be a computer software application (or set of applications) based upon the Windows operating systems from Microsoft Corp. of Redmond, Wash., the Unix operating system, for example, Solaris from Sun Microsystems of Palo Alto, Calif. or the LINUX operating system from, for example, Red Hat, Inc. of Durham, N.C. The voice application platform can be based upon the Tel@go System or the Personal Voice Portal System available from Comverse, Inc., Wakefield, Mass.

The remote application server 130 can be a computer based web and/or application server based upon the Windows operating systems from Microsoft Corp. of Redmond, Wash., the Unix operating system, for example, Solaris from Sun Microsystems of Palo Alto, Calif. or the LINUX operating system from, for example, Red Hat, Inc. of Durham, N.C. The web server can be based upon Microsoft's Internet Information Server platform or for example the Apache web server platform available from the Apache Software Foundation of Forest Hill, Md. The applications can communicate with the Voice Application Platform using VoiceXML or any other format that provides for communication of information defining a voice based user interface. The VoiceXML (or other format) information can be transmitted using any well known communication protocols, such as, for example HTTP.

The voice application platform 110 can communicate with the remote application/web server 130 via network 120, which can be a public network such as the Internet or a private network. Alternatively, the voice application platform 110 and the remote application server 130 can be separate applications that are executed on the same physical server or cluster of servers and communicate with each other over an internal data connection. It is not necessary for the invention that voice application platform 110 and the remote application server 130 be connected via any particular form or type of network or communications medium, nor that they be connected by the same network that connects the terminals 152, 154, and 156 to the voice application platform 110. It is only necessary that the voice application platform 110 and the remote application server 130 are able to communicate with each other.

Communication network 130 can be any public or private, wired or wireless, network capable of transmitting the communications of the terminals, 152, 154 and 156, the voice application platform 110 and the remote application/web server 130. Alternatively, communication network 130 can include a plurality of different networks, such as a public switched telephone network (PSTN) and a IP based network (such as the Internet) connected by the appropriate bridges and routers to permit the necessary communication between the terminals, 152, 154 and 156, the voice application platform 110 and the remote application/web server 130.

In accordance with the invention, the user interacts with a user interface provided by the voice application platform 110 (and remote applications 132) using terminals, such as, a computer 152, a telephone 154 and a mobile device (PDA or telephone) 156. The terminals 152, 154 and 156 can be connected to the voice application platform 110 via a public voice network such as the PSTN or a public data network such as the Internet. The terminals can also be connected to the voice application platform 110 via a wireless network connection such as an analog, digital or PCS network using radio or optical communications media. In addition, the terminals 152, 154 and 156, the voice application platform 110 and the remote application server 130 can all be connected to communicate with each other via a common wired or wireless communication medium and use a common communication protocol, such as, for example, voice over IP (“VoIP”).

In addition, the voice application platform of the present invention can be incorporated in any of the terminals 152, 154 or 156. For example, as shown in FIG.1, the computer 152 can include a voice application platform 144 and access remote applications and web pages 132 as well as local applications 142. In addition, it is not necessary that the voice application platform reside on a separate device on the network, the voice application platform 134 can be incorporated in the remote application/web server 130.

The voice application platform of the present invention can form part of a voice portal. The voice portal can serve as a central access point for the user to access several remote applications and web sites. The voice portal can use the voice application platform to provide a voice user interface (VUI) or a voice based browser that can include many of the benefits described herein. In this embodiment, there is potential for conflict between the voice commands of the voice user interface or voice browser provided by the voice portal and the remote applications and web sites, however through the use of the present invention, the voice portal can analyze the inputs from the remote applications to properly handle command conflicts as well as provide a more consistent interface for the user. For example, the voice portal may provide navigation commands such as “next,” “previous,” “go forward,” or “go back” and the remote application may also use the same or similar commands (“forward” or “back”) in one or more dialogs to navigate the remote application or web site.

The voice application platform can handle the conflict by first analyzing the inputs received from the remote application and identifying that it contains one or more commands that are the same as or similar to (contain some of the same words) the voice portal or voice browser commands. If the conflict exists, for example, if the command “previous” is used in both the remote application or web site and the voice portal, the voice application platform can determine (either prior to recognition or after a conflicting command is recognized) from the context of the voice browser or user interface whether the command “previous” can be executed by the voice application platform or the command should be sent to the remote application, i.e. if the current application is the first application visited by the voice browser in the session, there is no previous application or web site to visit, and thus, no point to executing the “previous” command on the voice browser level. In this case, the command is sent to the remote application. If the “previous” command can be executed on both the voice browser and the remote application levels, the voice application platform can, for example, either execute the command relative to one level (voice browser or remote application) based upon a predefined default preference or insert a dialog that asks the user which level the command should be applied to.

Similarly, the voice application platform can enable synonyms of commands and words that provide for better performance. There are many terms that people call common items, for example, a cellular telephone can also be called a cell, a cell phone, a mobile, a PCS and a car phone and a pager can also be called a handy pager and a beeper. In accordance with the invention, the voice application platform can analyze the inputs from the application and if, for example, the word cell or cellular telephone or pager or beeper is included in the acceptable user inputs, the voice application platform can add synonyms to the allowable user inputs to allow for better recognition performance. The voice application would also create a table of synonyms that were added and, based upon the words recognized, substitute the original word or term (from the original representation from the application of acceptable inputs) for a synonym that was recognized in the response and send the original word or term to the remote application.

Since the voice application platform 110 can provide additional services, such as voicemail services, the platform typically recognizes a set of commands, such as “next message”, related to those services. Preferably, the system always adds the commands related to these “built-in” services to the set of acceptable user inputs, so the user can access these services, even if he/she is interacting with a remote application 132. In addition, the system can add commands that activate other remote applications to the set of acceptable user inputs, so the user can switch between or among several remote applications. In this case, the system removes commands that are associated with the application being left and adds commands that are associated with the application being invoked.

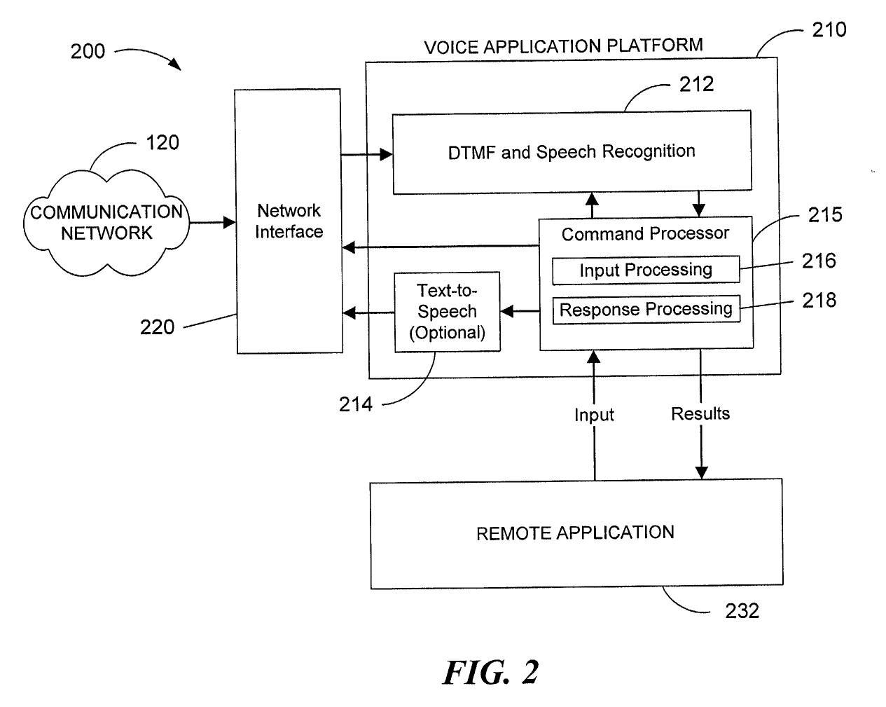

FIG. 2 shows a diagrammatic view of a system 200 providing a voice application platform 210 in accordance with the present invention. The voice application platform 210 includes a DTMF and speech recognition unit 212 optionally, a text-to-speech (TTS) engine 214, and a command processing unit 215. The system 200 further includes a network interface 220 for connecting the voice application platform 210 with user terminals (not shown) via communication network 120. The network interface 220 can be, for example, a telephone interface and a medium for connecting the user terminals with the voice application platform 210. The DTMF and speech recognition unit 212, the text-to-speech (TTS) engine 214, and a command processing unit 215 can be implemented in software, a combination of hardware and software or hardware on the voice application platform computer. The software can be stored on a computer-readable medium, such as a CD-ROM, floppy disk or magnetic tape.

The DTMF and speech recognition unit 212 can include any well known speech recognition engine such as Speechworks available from Speechworks International, Inc. of Boston, Mass., Nuance available from Nuance Communications, Inc. of Menlo Park, Calif. or Philips Speech Processing available from Royal Philips Electronics N.V., Vienna, Austria. The DTMF and speech recognition unit 212, can further include a DTMF decoder that is capable of decoding Touch Tone signals that are generated by a telephone and can be used for data input.

Typically, the speech recognition unit 212 will be based upon a language model or recognition paradigm that enables the recognizer to determine which words were spoken. Depending upon the language model or paradigm, the speech recognition unit may require an input that facilitates the recognition process. The input typically reduces the number of words the recognizer needs to recognize in order improve recognition performance. For example, the most common recognizers are constrained by an input, commonly referred to as a grammar. A grammar is a terse and partially symbolic representation of all the words that the recognizer should understand and orders (syntax) in which the words can be combined (during the recognition period for a single dialog).

Another common recognizer is a natural language speech recognizer based upon the N-gram language model which works from tables of probabilities of sequences of words. For example, the input to a bi-gram recognizer is a list of pairs of words with a probability (or weight) assigned to each pair. This list expresses the probabilities that the various word pairs occur in spoken input. For example, the pair “the book” is more common than “book the” and would be accorded a higher probability. The input to an N-gram recognizer is a list of N word phrases, with a probability assigned to each.

Another common recognizer is a “key word” recognizer which is designed to detect a small set of words from a longer sequence of words, such as a phrase or sentence. For example, numeric or digit key word recognizer would hear the sentence “I want to book two tickets on flight 354.” as “2 . . . 2 . . . 354.” The input for a key word recognizer is simply a list representative of a set of discrete words or numbers.

Alternatively, the speech recognition unit 212 can be of the type which does not require any input, such as an open vocabulary recognition system which can recognize any utterance or has a sufficiently large vocabulary such that no grammar is needed.

The Text-To-Speech (TTS) engine 214 is an optional component that can be provided where an application or web site provides prompts in the form of text and the voice application platform can use the TTS engine 214 to synthesize an audio prompt from the text. The TTS engine 214 can include software or a combination of hardware and software that is adapted for receiving data (such as text or text files), representative of prompts, and converting the data to audio signals which can be played to the user via the connection between the voice application platform and the user's terminal.

Alternatively, the prompts can be provided in any well known open or proprietary standard for storing sound in digital form, such as wave and MP3 sound formats. Where the prompts are provided in digital form, the voice application platform can use well known internal or external hardware devices (such as sound cards) and well known software routines to convert the digital sound data into electrical signals representative of the sound that is transmitted through the network interface 220 and over the network 120 to the user.

The command processing unit 215 can include an input processing unit 216 adapted to process the inputs received from the remote application 232 and a response processing unit 218 adapted to process the recognized user responses in accordance with the invention. The input processing unit 216 and the response processing unit 218 can work together to modify the user interface in accordance with the invention.

The command processing unit 215 is adapted for receiving input data from the application and sending responses to the application. The input data typically includes the grammar or other representation of the acceptable responses from the user and the prompt, either in the from of a digital audio data file or a text file for TTS synthesis. For simplicity, we will sometimes referred to a representation of acceptable responses from the user as a “grammar”, although other types of representations can be used, depending on the type of speech recognition technology used, as described above. The input processing unit 216 receives the input data and separates the grammar from the prompt. The grammar can be analyzed to determine specific characteristics or attributes of its content in order to enable the command processing unit 215 to determine or make assumptions about the response(s) that the application or web site is expecting. Optionally, if the prompt is a text file for TTS synthesis, the text file can be analyzed, alone or in combination with the above-described analysis of the grammar, to determine specific characteristics or attributes of the content that enable the command processing unit 215 to determine or make assumptions about the response that the application or web site is expecting. The input processing unit 216 can further include software or a combination of hardware and software that are adapted to execute an application or initiate an internal or external process or function to execute a command as a function of the analysis of the input and modified though the VUI, i.e. modified the prompt(s) played to the user, modify the acceptable inputs from the user and/or automatically generate responses to the application. For example, where the grammar is determined to be for user information that could be obtained from a stored user profile, such as a credit card number, telephone number, Social Security number, address, birth date or spouse's name, the input processing unit 216 can execute an application or process that sends the stored user's information to the application, either with or without prompting the user to do so. This eliminates a need for the user to utter a response to the prompt and can eliminate a need for the voice application platform to play the prompt from the remote application. The former enhances security when, for example, the remote application requires sensitive information, such as a Social Security number, but the user is using a public telephone in a crowded area. In another example, the voice application platform can include a database of synonyms or a thesaurus and where the grammar is determined to include one or more words that are found in the database or the thesaurus, the input processing unit 216 can add the appropriate synonyms to the grammar before it is forwarded to the speech recognition unit 212 and notify the response processing unit 218 that any synonyms recognized need to be replaced with the original term (from the original grammar) prior to forwarding the response to the application or web site. In a further example, where the grammar is determined to include words that conflict with words that are used in the voice user interface or voice browser, the input processing unit 216 can execute a function or a process that notifies the response processing unit 218 of the conflict so that the appropriate remedial action can be put in place to resolve the conflict (e.g. presume the command is for the application or web site or prompt the user to clarify which level the command should be executed on).

In general, various methods of analyzing grammars are well known and the particular methods employed will vary depending upon the format or syntax of the grammar and the system requirements, such as what utterances, words or phrases are to be tested or detected and what modifications can be made to the way the user can interact with the application. See for example, Elements of the Theory of Computation, by Harry R. Lewis and Christos H. Papadimitriou (Prentice-Hall, 1981), which is hereby incorporated by reference. The level of complexity of the grammar analysis is related to the degree of confidence a particular characteristic of a grammar is to be determined. For example, the grammar can be “tested” or analyzed when it is received from the remote application 232 to determine if it represents a group of numbers or digits and the number of digits in the group; a set of words representing a set of items, for example, days of the week or months of the year; or an affirmative or negative answer such as “yes” or “no.” Based upon one or more and possibly a series of these tests, the system can select (or not) a particular modification to the way the user can interact with the system and the application. The input processing unit 216 can include software or a combination of software and hardware that are adapted to analyze the grammar in order to determine characteristics or attributes of the expected response to enable the command processing unit 215 to make assumptions about the response the application is expecting.

In one method, specific words or phrases can be tested against a given grammar to determine whether a particular word or set of words or phrases are in the grammar. For example, a system to determine whether a grammar codes for a credit card number can include a heuristic analysis: first, the grammar could be parsed and/or searched to locate the utterances representing the number digits (zero through nine), next the grammar could be tested to determine if a number having the same number of digits as a credit card number (a 15 or 16 digit number) is in the grammar and finally, other types of numbers such as telephone numbers or zip codes could also be tested to verify that they are not in the grammar. Alternatively, a grammar emulator or interpreter can be provided that interprets the grammar, similar to the way the speech recognizer would interpret the grammar, and then the grammar could be tested with various words or utterances in order to determine what words or utterance the grammar codes for. In our credit card example, the grammar could first be tested for each numerical digit (zero through nine), then tested for a number having the same number of digits as a credit card number and then tested for numbers having more or less digits than a credit card number.

In one embodiment, each grammar could be subject to a heuristic analysis that relates to all or almost all of the possible modifications that a system could make to the way the user can interact with an application. For example, where a system stores a user addresses, birth date, zodiac sign, credit card numbers and expiration dates and allows for modification of the user interface by providing synonyms of commands (exit or stop in addition to quit), a systematic or heuristic methodology could be employed to determine whether a particular modification could be employed for a given grammar. The grammar could first be tested to determine whether it codes for words or numbers or both, such as by testing it with numbers and certain words (month names, zodiac signs, day names, etc.). If a grammar only codes for numbers, it could further be tested for types of numbers such as credit card numbers, telephone number or dates. If the grammar only codes for words, the grammar can further be tested for specific word groups or categories, such as month names, days of the week, signs of the zodiac, names of credit cards (Visa, MasterCard, American Express). The grammar can also be tested for command words like quit or next or go back or bookmark. Upon completion of this analysis, the system can have a higher level of confidence that the system has correctly inferred what kind of information the application seeks and whether a particular modification related to that kind of information may or may not be applicable.

For each dialog, this information can be stored by the system for future reference to provide context for subsequent dialogs. Thus, for example, if the previous grammar coded for a number that could be a credit card number, and the current grammar appears to code for a date, an assumption can be made that the date is a credit card expiration date and possibly invoke a process that sends a previously stored credit card expiration date.

The input processing unit 216 can also be adapted to modify an existing grammar by adding additional phrases or terms that can be recognized or substituting one or more terms or phrases for one or more other terms or phrases in the original grammar. The input processing unit 216 can be further adapted to associate a set of user responses and an action to be performed for each user response or an indication of a conflict between a voice user interface or voice browser response and a remote application response. Thus, for example, if the user response is one of the responses specified by the original grammar provided by the remote application 232, the associated action can be to send the response to the remote application 232, whereas if the response is, for example, also a voice user interface command or a voice browser command such as “help” or “quit,” the associated action can be to execute the appropriate voice user interface or browser process or function to resolve the conflict. The input processing unit 216 can create a list of user responses and associated actions to be performed. The list can be sent to the response processing unit 218 or stored in a memory that can be commonly accessed by both the grammar processing unit 216 and response processing unit 218.

The input processing unit can also include software or a combination of hardware and software that are adapted to analyze the text in a TTS prompt in order to determine characteristics or attributes of the expected response to enable the command processing unit 215 to make assumptions about the response that the application is expecting. This can be accomplished in a manner similar to the way grammars are analyzed, as described above, or more simply by parsing the text of the TTS prompt to search for key words or phrases. For example, where the TTS prompt includes the term “credit card” and the grammar is for the number of digits associated with a credit card, for example, 15 or 16 numeric digits, the input processing unit 216 can, for example, modify the grammar to recognize, instead of single digit number, number pairs (“twenty-two”) and number groupings (“twelve hundred”) as well as allow for a previously stored credit card number to be send to the remote application. Where the TTS prompt includes a key word associated with information stored in a user profile, such as a credit card number, a birthday or an address, this information can be sent automatically with or without prompting the user to do so. For example, the system can add “Use my MasterCard” to the list of acceptable user responses and, if this input is recognized, send prestored credit card information, such as an account number, expiration date, name is it appears on the card and/or billing address, depending on what responses the system is able to infer the application expects.

The response processing unit 218 can include software or a combination of hardware and software that are adapted to compare the user response (as interpreted by the speech recognition unit 212) with the list of responses produced by the input processing unit 216. The response processing unit 218 can further include software or a combination of hardware and software that are adapted to send, where appropriate, the user response to the remote application 232 or to execute an application or initiate an internal or external process to execute a command or perform a function that was associated by the input processing unit 216 with the received user response. Thus, where the user responds with “help,” the response processing unit 218 can, where appropriate, execute a help function or application that provides the user with one or more help dialogs or where appropriate forward the help response to the remote application. Alternatively, where a user says “Quit,” the system can compare “Quit” with the list of application expected responses and, where appropriate, send the command “Exit” (which is expected by the application) to the application in place of “Quit.”

The command processing unit 215 can further be adapted to modify the way the user can interact with the application as a function of the context of a given response. For example, where the original grammar represents a credit card number, the subsequent dialog based upon this context is expected to be either the name of the credit card holder or the expiration date of the credit card. Thus, the input processing unit 216 can set a context attribute as “credit card” upon receiving a grammar that represents the number of digits associated with a credit card. Upon receipt of a subsequent grammar that represents a date (month and year), based upon the current context attribute, the input process unit 216 can retrieve the user's expiration date from his/her profile and send it to the application with or without prompting the user to do so. Alternatively, if the original grammar represented the days of the week or months of the year, the response processing unit 218 can, in response to a user response for “help” where no help is provided by the remote application, select a help application or process that is appropriate for the context, such as explain the possible responses, for example, names of the days or months or the corresponding numbers.

The context information can be determined by the input processing unit 216 as part of its grammar processing function and sent to the response processing unit 218 or stored in memory that is mutually accessible by the input processing unit 216 and the response processing unit 218. Alternatively, the context information can be determined by the response processing unit 218 as a function of the list of possible responses prepared by the input processing unit 216.

In the illustrative embodiment, the remote application can, for example, be a VoiceXML based application that was developed for a use with a Nuance style grammar-based recognizer and the speech recognition unit in the voice application platform can be based upon a different recognition paradigm, such a bigram or n-gram recognizer. In accordance with the present invention, the command processing unit 215 can process the Nuance style grammar into a set of templates of possible user inputs and then, based upon the Nuance style grammar, translate the user response to be appropriate for the application. For example, where the VoiceXML application prompted the user with “In what month were you born?” and provided a grammar of just month names, it is not grammatical from the point of view of the VoiceXML application for the user to respond with “I was born in January” or “late January.” However, the bigram-based recognizer could recognize the whole response and the command processing unit 215 could parse out the month name and send it to the VoiceXML application.

Where the input processing unit 216 determines that a grammar is for a 15 or 16 digit number, the input processing unit 216 can supplement the grammar to allow the user to say for example, “Use my MasterCard” and supply the number directly if the user so states. The input processing unit 216 can also supplement the prompt to remind the user that the additional command is available, for example, “You can also say ‘Use my MasterCard.’” Alternatively, the input processing unit 216 can substitute the prompt with a request for permission to use the credit card on file, for example, “Do you want to user your MasterCard?” and substitute the grammar for a grammar with “yes” or “no” in order to provide the credit card stored in the user profile.

The system according to the invention can also send the user's credit card number and/or expiration date automatically to the remote application, without playing the prompts to the user. In this example, the grammar is not forwarded to the speech recognition unit and no user response is recognized. Alternatively, the grammar can be modified to remove the number digits and/or date words, but allow navigation and control commands like “stop,” “quit,” or “cancel,” thereby allowing the user to further navigate or terminate the session with the remote application.

Where the input processing unit 216 determines that the grammar is for a date, such as a month name or a two digit number with or without the year, the input processing unit can add to the grammar to allow the speech recognizer to recognize other appropriate words and terms, for example, “yesterday,” “next month,” “a week from Tuesday,” or “my birthday” and the response processing unit 218 can convert the response to the appropriate date term, for example, the month (with or without the year) and forward the converted response to the application.

Where the input processing unit 216 determines that the grammar is for “yes” or “no,” the input processing unit 216 can supplement the grammar to recognize synonyms such as “right,” “OK,” or “cancel,” and the response processing unit 218 can replace the synonym with the expected response term from the original grammar in the response sent to the remote application.

Where the input processing unit 216 determines that the grammar is for a number such as a credit card number, a telephone number, a social security number or currency, the input processing unit 216 can modify the grammar to include numeric groupings such as two digit number pairs (i.e. twenty-two) or larger grouping (i.e. two thousand or four hundred), in order to recognize a telephone number such as “four nine seven six thousand” or “four nine seven ninety-two hundred.” The input processing unit 216 can also enable the DTMF and speech recognizer to accept keyed entry on a numeric keypad, such as that on a telephone, using DTMF decoding or computer keyboard (where simulated DTMF tones are sent). Where the input processing unit 216 recognizes the number as a specific type of number, such as a telephone number or a social security number, the grammar can be modified to allow phrases that refer to numbers stored by the voice portal or the voice browser in a user profile, such as “Use my home telephone number” or “Use John Doe's work number.”

The process, in accordance with the invention, can provide an improved user interface, as disclosed herein, by providing a more adaptable, expandable and/or consistent user interface. The process, generally, includes the steps of analyzing the information representative of the responses expected by the application and modifying and/or adding to the set of responses expected in order to provide an improved user experience.

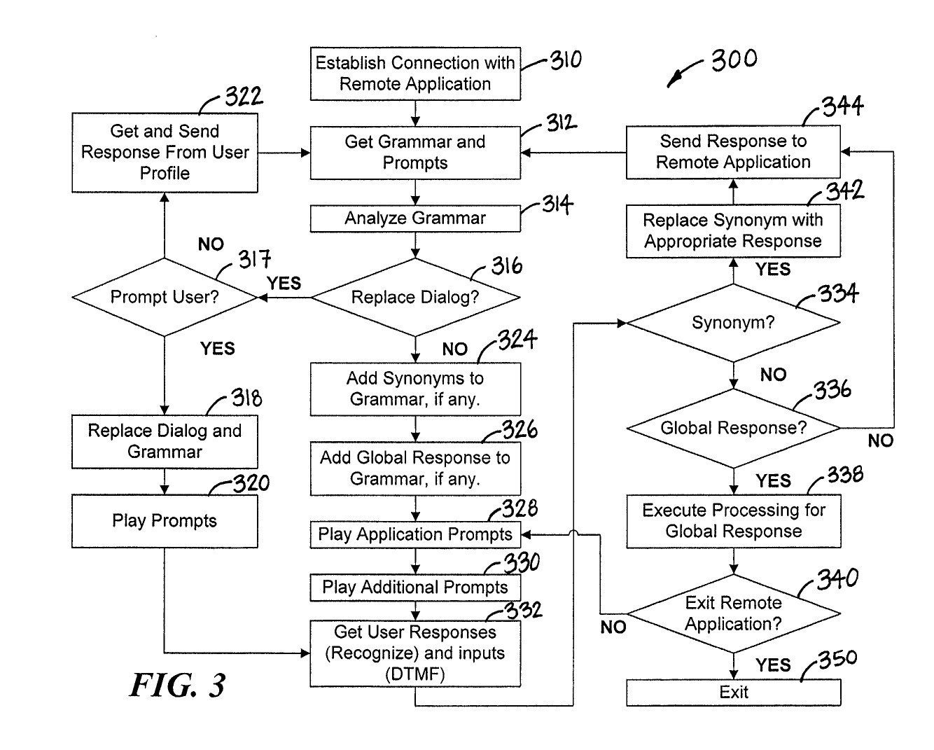

FIG. 3 shows a process 300 for providing a user interface in accordance with the invention. As stated above, the application can be any remote or local application or website that a user can interact with, either directly or over a network. In the illustrative embodiment, the remote application is adapted to send prompts and grammars to the voice application platform, however it is not necessary for the voice application platform to use a grammar. The process 300, in accordance with invention, includes establishing a connection with the application at step 310, either directly (such as where the application is local) or over a network, receiving input from the application at step 312. Typically, the input includes at least one prompt and one grammar. The process 300 further includes analyzing the grammar at step 314. The analyzing step 314 includes determining one or more characteristics of the response expected by the remote application in order to implement one or more modifications to the way the user can interact with the remote application. This can be accomplished by analyzing the grammar or the prompt (e.g. TTS based prompts) or both to determine the type or character of information requested by the prompt (e.g. a credit card number or expiration date) or the set of possible responses the user can input in response to the prompt (e.g. number strings and date terms). If one of the characteristics indicates that the user interface can either provide the information to the remote application without presenting the dialog to the user or can provide a substitute or replacement dialog, the process 300 can make that decision at step 316. If the dialog is to be replaced, the process determines whether the user needs to be prompted at step 317. If the user needs to be prompted, the replacement grammars are provided to the speech recognition unit 318 and the replacement prompt is played to the user 320. If the user interface can provide the information to the remote application without prompting the user, the information is retrieved from the user profile and forwarded to the application at step 322. For example, information stored in a user profile, such as, the user's name, address, or credit card information, can either be forwarded to the remote application without prompting the user (as in step 322) or by providing the user with a dialog that gives the user the option of using the information stored in the user profile, such as “Do you want to use the MasterCard in your profile or another credit card?” (as in steps 318 and 320). The voice application platform can be pre-configured to automatically insert the information from the user's profile without user intervention or require user authorization to provide information from the user profile.

If the dialog is not to be replaced, the voice application platform can look for words that are in its thesaurus or synonym database and can add synonyms and other words or phrases to the grammar 324 to improve the quality of the recognition function. For example, if the dialog is requesting the user to input their birthday, a grammar which merely recognizes dates (months and/or numbers), can be expanded to recognize responsive phrases such as “I was born on September twenty-fifth, nineteen sixty-one.” or “My birthday is May twelfth, nineteen ninety-five.” Similarly, the improved grammar could allow the user to input dates using only numbers such as “nine, twenty-five, sixty-one” (Sep. 25, 1961) or relative dates such as “A week from Friday.”

In addition to adding synonyms and other words to the grammar, the voice application platform can add global responses to the grammar 326, such as “Help” or “Quit.” Where the voice application platform has previously determined that the global responses conflict with application responses for the current dialog, the voice application platform can provide a process for resolving the conflict based upon a default preference to forward conflicting responses to the application or by adding a dialog which asks the user to select how the response should be processed. The solution for conflict resolution can be forwarded to a response processor that implements the solution in the event that the user response includes a conflicting response.

After the grammar has been replaced or modified, the application prompt is played to the user in step 328 and then any additional prompts are played to the user in step 330. This can be accomplished by playing an audio (for example wave or MP3) file or synthesizing the prompt using a TTS device. For example, after the application prompt is played, the user interface can provide the user with an indication of other services or commands that are available, such as “To automatically input user profile information say the phrase ‘Use My’ followed by profile identifier for the information you wish to the system to input.” would allow a user to, for example, say “Use my MasterCard number” to instruct the voice application platform to send the MasterCard number to the remote application. Alternatively, the additional prompt can be “You can also enter numbers using the keys on the number pad.” or “For voice portal commands say ‘Voice Portal Help’”

After the prompts are presented to the user, the user interface waits to receive a response from the user 332. The response can be a permitted response as defined by the grammar provided by the application or a response enabled by the voice application platform, such as a synonym, a global response or touch tone (DTMF) input.

The user response is analyzed at step 332 to determine whether it is a synonym for one of the terms permitted by the remote application. If the voice application platform detects that the user input is a synonym at step 334, the synonym is replaced with the appropriate response expected by the application at step 342 and the response is sent to the application at step 344. The process is again repeated at step 312 where another grammar and prompt are received from the remote application.

If the user response is not a synonym, it is analyzed by the voice application platform at step 336 to determine whether it contains a global response, such as a voice user interface or voice browser command. If a global response is received from the user at step 336, the user interface executes the associated application or process to carry out the function or functions associated with the global response at step 338. As stated above, this could include a Quit or Stop command, or a user interface command such as “Use my MasterCard.” If, in executing the global response, the remote application or the user session (connection to the user interface) is terminated 340, by the user responding “Quit” or hanging up, the process 300 can end at step 350. If the remote application is not terminated or the session is not terminated, the user interface continues on to play the application prompts at step 328 and the additional prompts at step 330 and the process continues.

If the user response is neither a synonym at step 334 or a global response at step 336, the process can continue at step 344 with the voice application platform sending the user response to the remote application. Optionally, the voice application platform can provide error handling, such that if the user response is not recognized, the voice application platform can prompt the user with “Your response is not recognized or not valid,” and then repeat the application prompt. In addition, the voice application platform can keep track of the number of not recognized or invalid responses and based upon this context, for example, three unrecognized or invalid responses, the voice application platform can add further help prompts to assist the user in responding appropriately. If necessary, the voice application platform can even change the form of the response, for example, to allow the user to input numbers using the key pad where, for example, the user interface is not able to recognize the user response due to the user's accent or physical disability (such as, stuttering or lisping).

In step 314, the voice application platform as part of the grammar analysis step, can also determine that the grammar is for a particular type of language model or recognition paradigm (different from the recognition language model or recognition paradigm used by the voice application platform) and as necessary include a conversion process that converts or constructs a grammar or other data appropriate for the language model or recognition paradigm being used, thus enabling the voice application platform to be compatible with applications developed for different speech recognition language models and recognition paradigms. For example, XML applications typically expect a grammar-based speech recognizer to be used, but an n-gram recognizer can enable the platform to present a richer, easier-to-use and more functional VUI. In addition, the platform can be configured with plural speech recognizers, each based on a different language model or recognition paradigm, such as grammar-based, n-gram and keyword. The platform could then choose which of these recognizers to use based on the inputs received from the application, the geographic location (and expected language, dialect, etc. of the user) or other criteria. For example, if the grammar is complex, the platform would preferably use the grammar-based recognizer, whereas if the grammar is simple, the platform would preferably use the n-gram or keyword recognizer, which would provide more accurate recognition. The conversion process can further include the steps of searching for and adding synonyms (thus obviating step 324) and adding global responses (thus obviating step 326). Alternatively, step 324 can include the conversion process that converts or constructs a grammar appropriate for the language model or recognition paradigm being used based upon the grammar analysis performed in step 314.

In addition, where the recognizer in the voice application platform does not require a grammar, the grammar analysis in step 314 can determine from the grammar or other input from the application, a list of words that are expected by the application and use the list to from a synonym table that can be used in step 334 to essentially validate the user response. Alternatively, the list of words can be used to create a template or other input to the speech recognizer to specify acceptable user inputs. For example, each word in the grammar would be indexed in the synonym table to itself. The synonym table can further be expanded to include additional possible user responses, such as relative dates (“next Monday” or “tomorrow”) or number groupings (“twenty-two” or “twelve hundred”) that enhance the user interface. Thus, where a user response appears in the synonym table, the appropriate response term from the original grammar would be substituted in step 342 for the recognized response and sent to the application in step 344. Alternatively, at step 334, prior to checking to see if the user response is a synonym, the voice application platform could check to see if the user response is in the list of words represented by the grammar provided by the application and if so, skip step 342 and send the response to the application at step 344.

Where the recognizer in the voice application platform does not require a grammar, steps 324 and 326 are not necessary. However, the grammar can be analyzed in step 314 to determine whether any additional prompts are appropriate. For example, notifying the user that specific global commands or additional functionality are available: “Use my MasterCard.” or “You can enter your credit card using the keys on your Touch Tone key pad. Press the # key when done.”

The invention may be embodied in other specific forms without departing from the spirit or essential characteristics thereof. The present embodiments are therefore to be considered in respects as illustrative and not restrictive, the scope of the invention being indicated by the appended claims rather than by the foregoing description, and all changes which come within the meaning and range of the equivalency of the claims are therefore intended to be embraced therein.

What is claimed is:

1. An apparatus comprising:
a general purpose computer including associated memory storage;
a voice application platform adapted for receiving a unit of input information from an application, said voice application platform including a speech recognizer for recognizing speech as a function of said unit of input information; and
a command processor adapted for analyzing a first unit of input information by said voice application platform and identifying a characteristic of said first unit of input information received and for modifying said first unit of input information to form a modified first unit of input information as a function of said characteristic.

2. An apparatus according to claim 1 wherein said first unit of input information includes a grammar.

3. An apparatus according to claim 1 wherein said characteristic is indicative that said first unit of input information includes a set of terms and said first unit of input information is modified to produce said modified first unit of input information that includes at least one additional term not included in said first unit of input information.

4. An apparatus according to claim 3 wherein said at least one additional term is a synonym of at least one term in said set of terms.

5. An apparatus according to claim 3 wherein said at least one additional term can be part of a phrase within which at least one term in said set of terms can be used.

6. An apparatus according to claim 3 wherein said at least one additional term is associated with a first function that can be performed when said voice application platform recognizes said at least one addition term.

7. An apparatus according to claim 3 wherein said set of terms is representative of a set of responses expected to be received by said application and said at least one additional term is a synonym of at least one term in said set of terms.

8. An apparatus according to claim 3 wherein said set of terms is representative of a set of responses expected to be received by said application and said at least one additional term is associated with a first function that can be performed when said voice application platform recognizes said at least one addition term, whereby said first function is adapted to include in a response to be sent to said application, at least one term in said set of terms.

9. An apparatus according to claim 8 wherein said first function is further adapted for substituting said at least one term in said set of terms for said at least one additional term in a response to be sent to said application.

10. An apparatus according to claim 3 wherein said set of terms is representative of a set of responses expected to be received by said application and said at least one additional term is associated with a first function that can be performed when said voice application platform recognizes said at least one addition term, whereby said first function is adapted to include, in a response to be sent to said application, a term selected from a memory as a function of said at least one additional term recognized by said voice application platform.

11. An apparatus according to claim 10 wherein said term selected from a memory is associated with a user of said voice application platform.

12. An apparatus according to claim 3, wherein said command processor is connected to said speech recognizer and adapted for receiving user responses recognized by said speech recognizer and for modifying said user response if said response matches one of said additional terms of the modified first unit of input information.

13. An apparatus according to claim 1 wherein said first unit of input information includes a first type of input information associated with a first speech recognizer based upon a first speech recognition paradigm and said first unit of input information is modified to produce a second unit of input information which includes a second type of input information associated with a second speech recognizer based upon a second speech recognition paradigm which is different from said first speech recognition paradigm.

14. An apparatus according to claim 13 wherein said second unit of input information includes input information that is the speech equivalent to the input information in said first unit of input information with respect to the speech recognized.

15. An apparatus according to claim 13 wherein said first unit of input information represents a first set of terms and said second unit of input information represents a second set of terms and said first set of terms is a subset of said second set of terms.

16. An apparatus according to claim 1 further comprising a prompt synthesizer adapted for receiving information representative of a prompt, and wherein said first unit of input information includes information representative of a prompt and said command processor receives said information representative of a prompt and said command processor modifies said first unit of input information as a function of said information representative of a prompt.

17. An apparatus according to claim 1 further comprising a prompt synthesizer adapted for receiving information representative of a prompt, and wherein information representative of a first prompt is received from said application and said voice application platform is adapted for presenting said first prompt to a user and a second prompt to said user.

18. An apparatus comprising:
a general purpose computer including associated memory storage;
a voice application platform adapted for receiving a unit of input information from an application, said voice application platform including a speech recognizer for recognizing speech as a function of said unit of input information; and
an command processor adapted for analyzing a first unit of input information and identifying a characteristic of said first unit of information received by said voice application platform and for replacing said first unit of information with a second unit of input information selected as a function of said characteristic.

19. An apparatus according to claim 18 wherein said first unit of input information is a grammar and said second unit of input information is a grammar.

20. An apparatus according to claim 18 wherein said characteristic is indicative that said first unit of input information includes a first set of terms and said second unit of input information includes at least one term not included in said first set of terms of.

21. An apparatus according to claim 20 wherein said at least one term is a synonym of at least one term in said first set of terms.

22. An apparatus according to claim 20 wherein said at least one term can be part of a phrase within which at least one term in said first set of terms can be used.

23. An apparatus according to claim 20 wherein said at least one term is associated with a function that is performed by said voice application platform.

24. An apparatus according to claim 20 wherein said set of first terms is representative of a set of responses expected by said application and said at least one term is a synonym of at least one term in said first set of terms.

25. An apparatus according to claim 20 wherein said first set of terms is representative of a set of responses expected by said application and said at least one term is associated with a function that is performed when said voice application platform recognizes said at least one term, whereby said function is adapted to include in a response to be sent to said application, at least one term in said set of terms.

26. An apparatus according to claim 25 wherein said function is further adapted for substituting said at least one term in said set of terms for said at least one term in a response to be sent to said application.

27. An apparatus according to claim 20 wherein said first set of terms is representative of a set of responses expected by said application and said at least one term is associated with a function that is performed when said voice application platform recognizes said at least one term, whereby said function is adapted to include in a response to be sent to said application, a term selected from a memory as a function of said at least one term recognized by said voice application platform.

28. An apparatus according to claim 27 wherein said term selected from a memory is associated with a user of said voice application platform.

29. An apparatus according to claim 20, wherein said command processor is connected to said speech recognizer and further adapted for receiving user responses recognized by said speech recognizer and for modifying said user response if said response matches said at least one term included in said first set of terms.

30. An apparatus according to claim 18 wherein said first unit of input information includes a first type of input information associated with a first speech recognizer based upon a first speech recognition paradigm and said first unit of input information is replaced with a second unit of input information which includes a second type of input information associated with a second of speech recognizer based upon a second speech recognition paradigm.

31. An apparatus according to claim 30 wherein said second unit of input information is the speech equivalent to said first unit of input information with respect to the speech recognized.

32. An apparatus according to claim 30 wherein said first unit of input information represents a first set of terms and said second unit of input information represents a second set of terms and said first set of terms is a subset of said second set of terms.

33. An apparatus according to claim 18 further comprising a prompt synthesizer for receiving information representative of a prompt, and wherein said first unit of input information includes information representative of a first prompt and said command processor receives said information representative of said first prompt and said command processor modifies said first unit of input information as a function of said information representative of said first prompt.

34. An apparatus according to claim 18 further comprising a prompt synthesize for receiving information representative of a prompt, and wherein said information representative of said first prompt is received from said application and said voice application platform is adapted for presenting said first prompt to a user and a second prompt to said user.

35. A method of providing a user interface comprising:
receiving a first unit of input information from an application, said first unit of input information including information representative of a first set of responses expected to be received by the application;
analyzing said first unit of input information to identify a characteristic of said first unit of input information;
modifying said first unit of input information as a function of said characteristic of first unit of input information to produce a second unit of input information representative of a second set of responses.

36. A method according to claim 35 wherein said first set of input information includes a first grammar.

37. A method according to claim 35 wherein said first set of responses represented by said first unit of input information is a subset of the second set of response represented by said second unit of input information.

38. A method according to claim 35 wherein said second set of responses represented by said second unit of input information includes at least one response that is not included in said first set of response represented by said first set of input information.

39. A method according to claim 35 wherein said first set of responses represented by said first unit of input information and said second set of response represented by said second unit of input information have a subset of responses in common with the responses represented by the first unit of information and the second information.

40. A method according to claim 35 wherein said first unit of input information is representative of responses expected by said application and said second unit of input information is representative of a second set of responses that includes at least one response that is a synonym of at least one response in said first set of responses.

41. A method according to claim 35 wherein said first unit of input information is representative of responses expected by said application and said second unit of input information is representative of a second set of responses that includes at least one response that is not included in said first set of responses.

42. A method according to claim 41 further comprising the steps of:
receiving said at least one response not included in said first set of responses and
executing a function associated with said at least one response not included in said first set of responses.

43. A method according to claim 42 further comprising the steps of:
producing a resulting response including a response from said first set of responses and
sending said resulting response to said remote application.

44. A method according to claim 35 wherein said first unit of input information includes a first type of input information associated with a first speech recognizer based upon a first speech recognition paradigm and is modified to produce said second unit of input information which includes as second type of input information associated with a second speech recognizer based upon a second speech recognition paradigm which is different from said first speech recognition paradigm.

45. A method according to claim 44 wherein said second unit of input information includes input information that is the speech equivalent to the input information in said first unit of input information with respect to the speech recognized.

46. A method according to claim 44 wherein said first unit of input information represents a first set of terms and said second unit of input information represents a second set of terms and said first set of terms is a subset of said second set of terms.

47. A method according to claim 35 wherein said first unit of input information includes information representative of a prompt presented by said application, said method further comprising the steps of:
analyzing said information representative of a prompt to identify a characteristic of said information representative of a prompt and
modifying said first unit of input information as a function of said characteristic of said information representative of a prompt to produce a second unit of input information representative of a second set of responses.

48. A method of providing a user interface comprising:
receiving a first unit of input information from an application, said first unit of input information including information representative of a first set of responses expected to be received by said application;
analyzing said first unit of input information to identify a characteristic of said first unit of input information;
replacing said first unit of input information with a second unit of input information representative of a second set of responses selected as a function of said characteristic of first unit of information.

49. A method according to claim 48 wherein said first set of input information is a first grammar.

50. A method according to claim 48 wherein said first set of responses represented by said first unit of input information is a subset of the second set of responses represented by said second unit of input information .

51. A method according to claim 48 wherein said second set of responses represented by said second unit of input information includes at least one response that is not included in said first set of responses represented by said first set of input information.

52. A method according to claim 48 wherein said first set of responses represented by said first unit of input information and said second set of responses represented by said second unit of input information have a subset of responses in common with the responses represented by the first unit of information and the second information.

53. A method according to claim 48 wherein said first unit of input information is representative of responses expected by said application and said second unit of input information is representative of a second set of responses that includes at least one response that is a synonym of at least one response in said first set of responses.

54. A method according to claim 48 wherein said first unit of input information is representative of responses expected by said application and said second unit of input information is representative of a second set of responses that includes at least one response that is not included in said first set of responses.

55. A method according to claim 54 further comprising the steps of:
receiving said at least one response not included in said first set of responses and
executing a function associated with said at least one response not included in said first set of responses.

56. A method according to claim 55 further comprising the steps of:
producing a resulting response including a response from said first set of responses and
sending said resulting response to said remote application.

57. A method according to claim 48 wherein said first unit of information includes a first type of input information associated with a first type of speech recognizer based upon a first speech recognition paradigm and is replaced by said second unit of input information which includes as second type of input information associate with a type of speech recognizer based upon a second speech recognition paradigm which is different from said first speech recognition paradigm.

58. A method according to claim 57 wherein said second unit of input information includes input information that is the speech equivalent to the input information in said first unit of input information with respect to the speech recognized.

59. A method according to claim 57 wherein said first unit of input information represents a first set of terms and said second unit of input information represents a second set of terms and said first set of terms is a subset of said second set of terms.

60. A method according to claim 48 wherein said first unit of input information includes information representative of a prompt presented by said application, said method further comprising the steps of:
analyzing said information representative of a prompt to identify a characteristic of said information representative of a prompt and
replacing said first unit of input information with a second unit of input information representative of a second set of responses as a function of said characteristic of said information representative of a prompt to produce.

61. An apparatus comprising:
a general purpose computer including associated memory storage;
a voice application platform adapted for receiving a unit of input information from and sending a response to an application, said voice application platform including a speech recognizer for recognizing speech as a function of said unit of input information; and
a command processor adapted for analyzing a first unit of input information and identifying a characteristic of a first unit of input information input into said voice application platform and for selecting a response to be sent to said application as a function of said characteristic.

62. An apparatus according to claim 61 wherein said first unit of input information includes a grammar.

63. An apparatus according to claim 61 wherein said characteristic is indicative that said first unit of input information includes a set of terms.

64. An apparatus according to claim 63 wherein said set of terms is representative of a numeric value.

65. An apparatus according to claim 63 wherein said set of terms is selected from the group including days of the week, months of the year and years.

66. An apparatus according to claim 61 wherein said input processor is adapted for sending said response to said application without said speech recognizer recognizing speech.

67. An apparatus according to claim 61 further including a prompt generator adapted for generating a prompt, and said input processor is adapted for sending said response to said application without generating a prompt.

68. An apparatus according to claim 61 further including a prompt generator adapted for generating a prompt, wherein said unit of input information includes information representative of a first prompt and said input processor is adapted for sending said response to said application without generating said first prompt.

69. An apparatus according to claim 61 further including a prompt generator adapted for generating a prompt, wherein said unit of input information includes information representative of a first prompt and said input processor is adapted for modifying said first prompt to create a second prompt including said first prompt and an additional prompt, and for sending said response to said application as a function of said characteristic of said first unit of input information and if said speech recognizer recognizes a user response corresponding to a response to said additional prompt.

70. An apparatus according to claim 69 wherein said first unit of input information includes information representative of an account number, said response to be sent to said application is an account number and said additional prompt represents a query asking for authorization to include said account number in said response.

71. An apparatus according to claim 61 wherein said response is a predefined response, stored in memory accessible by said voice application platform.

72. An apparatus according to claim 61 wherein said predefined response is associated with a user of said voice application platform.

73. An apparatus according to claim 61 wherein said voice application platform is further adapted for receiving a second unit of input information and for selecting a second response to send to said application as a function of said characteristic of said first unit of information.

74. An apparatus according to claim 73 wherein said voice application platform is further for identifying a characteristic of said second unit of input information and for selecting a second response to send to said application as a function of said characteristic of said second unit of information.

75. A method of providing a user interface comprising:
receiving a first unit of input information from an application, said first unit of input information including information representative of a first set of responses expected to be received by the application;
analyzing said first unit of input information to identify a characteristic of said first unit of input information;
selecting a response to be sent to said application as a function of said characteristic of first unit of input information.

76. A method according to claim 75 wherein said first set of input information includes a grammar.

77. A method according to claim 75 wherein said characteristic is indicative that said first unit of input information includes a set of terms.

78. A method according to claim 77 wherein said set of terms is representative of a numeric value.

79. A method according to claim 77 wherein said set of terms is selected from the group including days of the week, months of the year and years.

80. A method according to claim 75 further comprising the step of sending said selected response to said application.

81. A method according to claim 80 wherein said selected response is sent to said application without receiving input from a user.

82. A method according to claim 75 wherein said first unit of input information includes information representative of a prompt and said selected response is sent to said application without presenting a prompt to a user.

83. A method according to claim 75 wherein said first unit of input information includes information representative of a prompt and said selected response is sent to said application without presenting said prompt to a user.

84. A method according to claim 75 wherein said first unit of input information includes information representative of a first prompt and said method further comprises the steps of selecting a presenting a second prompt as a function said characteristic of said first unit of input information and presenting said second prompt to a user.

85. A method according to claim 84 further comprising the step of presenting said first prompt to said user.

86. A method according to claim 85 wherein said first unit of input information includes information representative of an account number, said response is a user account number, and said second prompt is a query asking said user for authorization to include said user account number in said response.

87. A method according to claim 75 wherein said step of selecting a response to be sent to said application as a function of said characteristic of first unit of input information, includes selecting a predefined response stored in a memory storage device.

88. A method according to claim 75 wherein said selected response is associated with a user of said user interface.

89. A method according to claim 75 further comprising the steps of receiving a second unit of input information from said application and selecting a second response to send to said application as a function of said characteristic of said first unit of information.

90. A method according to claim 75 further comprising the steps of
receiving a second unit of input information from said application;
analyzing said second unit of input information to identify a characteristic of said second unit of input information;
selecting a response to be sent to said application as a function of said characteristic of second unit of input.

91. An apparatus comprising:
general purpose computing means for processing data, including associated memory means for storing data;
voice application platform means for receiving a unit of input information from an application, said voice application platform means including a speech recognition means for recognizing speech as a function of said unit of input information; and
command processing means for analyzing a first unit of input information and identifying a characteristic of said first unit of input information received by said voice application platform means and for modifying said first unit of information as a function of said characteristic.

92. An apparatus according to claim 91 wherein said first unit of input information includes a grammar.

93. An apparatus according to claim 91 wherein said characteristic is indicative that said first unit of input information is representative of a first set of terms and said first unit of input information is modified to represent at least one additional term not included in said first set of terms.

94. An apparatus according to claim 93 wherein said at least one additional term is a synonym of at least one term in said first set of terms.

95. An apparatus according to claim 93 wherein said at least one additional term can be part of a phrase within which at least one term in said first set of terms can be used.

96. An apparatus according to claim 93 wherein said at least one additional term is associated with a first function that can be performed when said speech recognition means recognizes said at least one addition term.

97. An apparatus according to claim 93 wherein said first set of terms is representative of a set of responses expected to be received by said application and said at least one additional term is a synonym of at least one term in said set of terms.

98. An apparatus according to claim 93 wherein said first set of terms is representative of a set of responses expected to be received by said application and said at least one additional term is associated with a first function that can be performed when said voice application platform recognizes said at least one addition term, whereby said function is adapted to include in a response to be sent to said application, at least one term in said first set of terms.

99. An apparatus according to claim 98 wherein said function is further adapted for substituting said at least one term in said first set of terms for said at least one additional term in a response to be sent to said application.

100. An apparatus according to claim 93 wherein said first set of terms is representative of a set of responses expected to be received by said application and said at least one additional term is associated with a first function that can be performed when said speech recognition means recognizes said at least one addition term, whereby said function is adapted to include in a response to be sent to said application, a term selected from a memory as a function of said at least one additional term recognized by said speech recognition means.

101. An apparatus according to claim 100 wherein said term selected from a memory is associated with a user of said voice application platform means.

102. An apparatus according to claim 93, wherein said command processing means is connected to said speech recognition means and includes means for receiving user responses recognized by said speech recognition means and means for modifying said user response if said response matches one of said additional terms of the modified first unit of input information.

103. An apparatus according to claim 91 wherein said first unit of input information includes a first type of input information associated with a first speech recognition means based upon a first speech recognition paradigm and said first unit of input information is modified to produce a second unit of input information which includes a second type of input information associated with a second speech recognition means based upon a second speech recognition paradigm which is different from said first speech recognition paradigm.

104. An apparatus according to claim 103 wherein said second unit of input information includes input information that is the speech equivalent to the input information in said first unit of input information with respect to the speech recognized.

105. An apparatus according to claim 103 wherein said first unit of input information represents a first set of terms and said second unit of input information represents a second set of terms and said first set of terms is a subset of said second set of terms.

106. An apparatus according to claim 91 further comprising prompt synthesizer mean for receiving information representative of a prompt and for presenting a prompt to a user, and wherein said first unit of input information includes information representative of a prompt and said command processor receives said information representative of a prompt and said command processing means modifies said first unit of input information as a function of said information representative of a prompt.

107. An apparatus according to claim 91 further comprising a prompt synthesizer means for receiving information representative of a prompt and for presenting a prompt to a user, and wherein said information representative of said first prompt is received from said application and said voice application platform means is adapted for presenting said first prompt to a user and a second prompt to said user.

108. An apparatus comprising:
general purpose computing means for processing data, including associated memory means for storing data;
voice application platform means for receiving a unit of input information from an application, said voice application platform including a speech recognition means for recognizing speech as a function of said unit of input information; and
command processing means for analyzing a first unit of input information and identifying a characteristic of said first unit of information received by said voice application platform and for replacing said first unit of information with a second unit of input information selected as a function of said characteristic.

109. An apparatus according to claim 108 wherein said first unit of input information includes a grammar and said second unit of input information includes a grammar.

110. An apparatus according to claim 108 wherein said characteristic is indicative that said first unit of input information is representative of a first set of terms and said second unit of input information is representative of a second set of terms that includes at least one additional term not included in said first set of terms of.

111. An apparatus according to claim 110 wherein said at least one additional term is a synonym of at least one term in said first set of terms.

112. An apparatus according to claim 110 wherein said at least one additional term can be part of a phrase within which at least one term in said first set of terms can be used.

113. An apparatus according to claim 110 wherein said at least one additional term is associated with a function that is performed by said voice application platform means.

114. An apparatus according to claim 110 wherein said set of first terms is representative of a set of responses expected by said application and said at least one additional term is a synonym of at least one term in said first set of terms.

115. An apparatus according to claim 110 wherein said first set of terms is representative of a set of responses expected by said application and said at least one additional term is associated with a function that is perform when said speech recognition means recognizes said at least one additional term, whereby said function said function is adapted to include in a response to be sent to said application, whereby said function said function is adapted to include in a response to be sent to said application, at least one term in said set of terms.

116. An apparatus according to claim 115 wherein said function is further adapted for substituting said at least one term in said set of terms for said at least one additional term in a response to be sent to said application.

117. An apparatus according to claim 110 wherein said first set of terms is representative of a set of responses expected by said application and said at least one additional term is associated with a function that is performed when said speech recognition means recognizes said at least one additional term, whereby said function said function is adapted to include in a response to be sent to said application, a term selected from a memory as a function of said at least one additional term recognized by said voice application platform.

118. An apparatus according to claim 117 wherein said term selected from a memory is associated with a user of said voice application platform means.

119. An apparatus according to claim 110, wherein said command processing means is connected to said speech recognition means, said command processing means further including means for receiving a user response recognized by said speech recognition means and for modifying said user response if said response matches one of said additional terms of the second unit of input information.

120. An apparatus according to claim 108 wherein said first unit of input information includes a first type of input information associated with a first speech recognition means based upon a first speech recognition paradigm and said first unit of input information is replaced with a second unit of input information which includes a second type of input information associated with a second of speech recognition means based upon a second speech recognition paradigm.

121. An apparatus according to claim 120 wherein said second unit of input information is the speech equivalent to said first unit of input information with respect to the speech recognized.

122. An apparatus according to claim 120 wherein said first unit of input information represents a first set of terms and said second unit of input information represents a second set of terms and said first set of terms is a subset of said second set of terms.

123. An apparatus according to claim 108 further comprising prompt synthesizer means for receiving information representative of a prompt and for presenting a prompt to a user, and wherein said first unit of input information includes information representative of a prompt and said command processing means includes means for receiving said information representative of a prompt and said command processing means includes means for modifying said first unit of input information as a function of said information representative of a prompt.

124. An apparatus according to claim 108 further comprising a prompt synthesizer means for receiving information representative of a first prompt and for presenting a prompt to a user, and wherein said information representative of said first prompt is received from said application and said voice application platform means includes means for presenting said first prompt to a user and second prompt to said user.

125. An apparatus comprising
a general purpose computer including associated memory storage;
a voice application platform adapted for receiving a unit of input information from and sending a response to an application, said voice application platform including a speech recognizer for recognizing speech as a function of said unit of input information and a prompt generator adapted for producing a prompt as function of said unit of input information;
a first processor adapted for analyzing a first unit of input information and identifying a characteristic of a first unit of input information received from said voice application platform and for producing a second unit of input information as a function of said characteristic
a second processor adapted for selecting a response to be sent to said application as a function of said characteristic.

126. An apparatus according to claim 125 wherein said response to be sent to said application is selected from memory.

127. An apparatus according to claim 125 wherein said response to be sent to said application is selected from memory and said response is associated with a user of said voice application platform.

128. An apparatus according to claim 125 wherein said response to be sent to said application is selected from memory and said response includes personal information associated with a user of said voice application platform.

129. An apparatus according to claim 125 wherein said response to be sent to said application is selected from memory and said response includes an account number associated with a user of said voice application platform.

130. An apparatus comprising
a general purpose computer including associated memory storage;
a voice application platform adapted for receiving a unit of input information from and sending a response to an application, said voice application platform including a speech recognizer for recognizing speech as a function of said unit of input information and a prompt generator adapted for producing a prompt as function of said unit of input information;
a first processor adapted for analyzing a first unit of input information and identifying a characteristic of a first unit of input information received from said voice application platform and for producing a second unit of input information as a function of said characteristic
a second processor adapted for analyzing a received response recognized by said speech recognizer and for selecting a response to be sent to said application as a function of said received response.

131. An apparatus according to claim 130 wherein said response to be sent to said application is selected from memory.

132. An apparatus according to claim 130 wherein said response to be sent to said application is selected from the group including the received response and responses stored in memory.

133. An apparatus according to claim 130 wherein said response to be sent to said application is a synonym of said received response.
